(19) United States
(12) Patent Application Publication
(10) Pub. No.: US 2011/0228394 A1
(43) Pub. Date: Sep. 22, 2011

(54) ZOOM LENS

(75) Inventor: Kenichi KUBO, Utsunomiya-shi (JP)

(73) Assignee: CANON KABUSHIKI KAISHA, Tokyo (JP)

(21) Appl. No.: 13/038,591

(22) Filed: Mar. 2, 2011

(30) Foreign Application Priority Data
Mar. 19, 2010 (JP) 2010-063688

(51) Int. Cl. G02B 27/64

(52) U.S. Cl. 359/557; 359/554

(57) ABSTRACT

A zoom lens includes a magnification-varying lens unit moving in an optical axis direction; a movable optical unit arranged in an object side of the magnification-varying lens unit; and a controller for moving the optical unit and the zoom lens displacing an image. A movable range of the optical unit is larger at a wide angle end than at a telephoto end. The zoom lens further includes a position detecting unit for detecting a relative position of the magnification-varying lens unit; and a position computing unit for computing a position of the magnification-varying lens unit. It is driven to a reference position immediately after power-on, then its position stored in the position computing unit is initialized to the reference position, then it is driven to a position at power-on, and then the movable range of the optical unit is set so as to correspond to the position of the magnification.

### BACKGROUND OF THE INVENTION

1. Field of the Invention

The present invention relates to a zoom lens apparatus having an image blur correcting function.

2. Description of the Related Art

In recent years, screens of television sets and monitors have been enlarged and their resolution has been increased. Therefore, there has been an increasing demand for images to be displayed with higher quality. To meet the demand for higher image quality, a zoom lens for broadcasting is provided with an optical encoder capable of highly accurate position detection, and hence lens control has higher performance (Japanese Patent Application Laid-Open No. 2005-284042).

Further, the zoom lens is developed to have a higher magnification factor and a larger focal length, which accordingly raises a problem of image motion on a telephoto side caused by vibration of a platform on which a camera and a lens apparatus are mounted and by wind-induced lens vibration.

Therefore, there has been developed a zoom lens having an image blur correcting function in which part of a lens unit constituting the zoom lens is driven to correct image motion caused by vibration. In a case where a focal length and an image blur correcting amount are large, however, there is a problem that influence of chromatic aberration caused by decentering an optical axis of an image blur correcting lens is significant. Therefore, to reduce the influence of chromatic aberration caused by image blur correction, there is proposed such a zoom lens having an image blur correcting function that the image blur correcting amount is reduced with an increase in focal length (Japanese Patent No. 3,543,999).

However, the conventional zoom lens apparatus having an image blur correcting function employs a relative position detector such as an optical encoder to detect a position of a zoom unit, and hence the position of the zoom unit cannot be grasped accurately immediately after power-on. Accordingly, the image blur correcting amount cannot be set appropriately to the current focal length, and hence it is very difficult to reduce the chromatic aberration, which raises a demand for measures thereagainst. In view of the above, it is an object of the present invention to provide a zoom lens apparatus having an image blur correcting function capable of reducing, immediately after the power-on, the chromatic aberration caused by the image blur correction.

### SUMMARY OF THE INVENTION

According to an aspect of the present invention, there is provided a zoom lens including: a magnification-varying lens unit, which moves in an optical axis direction during varying magnification; an optical unit, which is movable and arranged in an object side of the magnification-varying lens unit; and a controller for moving the optical unit, in which the optical unit is moved to displace an image, and in which a movable range of the optical unit at a wide angle end is larger than a movable range of the optical unit at a telephoto end.

According to a further aspect of the present invention, the zoom lens further includes: a position detecting unit for detecting a relative position of the magnification-varying lens unit; and a position computing unit for computing a position of the magnification-varying lens unit based on the detected relative position of the magnification-varying lens unit, in which the magnification-varying lens unit is driven to a reference position immediately after power-on, then the position of the magnification-varying lens unit stored in the position computing unit is initialized to the reference position, then the magnification-varying lens unit is driven to a position at the time of the power-on, and then the movable range of the movable optical unit according to the position of the magnification-varying lens unit is set.

According to a further aspect of the present invention, the zoom lens further includes: a position detecting unit for detecting a relative position of the magnification-varying lens unit; a position computing unit for computing a position of the magnification-varying lens unit based on the detected relative position of the magnification-varying lens unit; an initialization selecting unit for selecting a method of initializing the position of the magnification-varying lens unit stored in the position computing unit; and a position storing unit for storing a position of the magnification-varying lens unit at the time when power of the zoom lens is turned off, in which when the initialization selecting unit is set so as to perform initialization, the magnification-varying lens unit is driven to a reference position immediately after power-on, then the position of the magnification-varying lens unit stored in the position computing unit is initialized to the reference position, then the magnification-varying lens unit is driven to a position at the time of the power-on, and then the movable range of the optical unit according to the position of the magnification-varying lens unit is set, and in which when the initialization selecting unit is set so as not to perform the initialization, the movable range of the optical unit is set so as to correspond to a state of the position storing unit.

According to the present invention, there is produced an effect of reducing, immediately after the power-on, the chromatic aberration caused by the image blur correction irrespective of the position of the zoom unit, the initialization method, and the mode of the image blur correction.

Further features of the present invention will become apparent from the following description of exemplary embodiments with reference to the attached drawings.

### BRIEF DESCRIPTION OF THE DRAWINGS

FIG. 1 is a configuration diagram according to a first embodiment of the present invention.

FIG. 2 is comprised of FIGS. 2A and 2B showing a flow chart illustrating an operation according to the first embodiment.

FIG. 3 is a graph showing a relationship between a focal length and an image blur correcting angle.

FIG. 4 is comprised of FIGS. 4A and 4B showing a flow chart illustrating an operation according to a second embodiment of the present invention.

FIG. 5 is a detailed configuration diagram of a zoom unit position detector.

FIG. 6 is a configuration diagram according to a third embodiment of the present invention.

FIG. 7 is a flow chart illustrating an operation according to the third embodiment.

FIG. 8 is a flow chart illustrating an interrupting operation according to the third embodiment.

FIG. 9 is a configuration diagram according to a fourth embodiment of the present invention.

FIG. 10 is a flow chart illustrating an operation according to the fourth embodiment.

FIG. 11 is a configuration diagram according to a fifth embodiment of the present invention.

FIG. 12 is a flow chart illustrating an operation according to the fifth embodiment.

### DESCRIPTION OF THE EMBODIMENTS

### First Embodiment

Hereinbelow, exemplary embodiments of the present invention are described in detail with reference to the attached drawings.

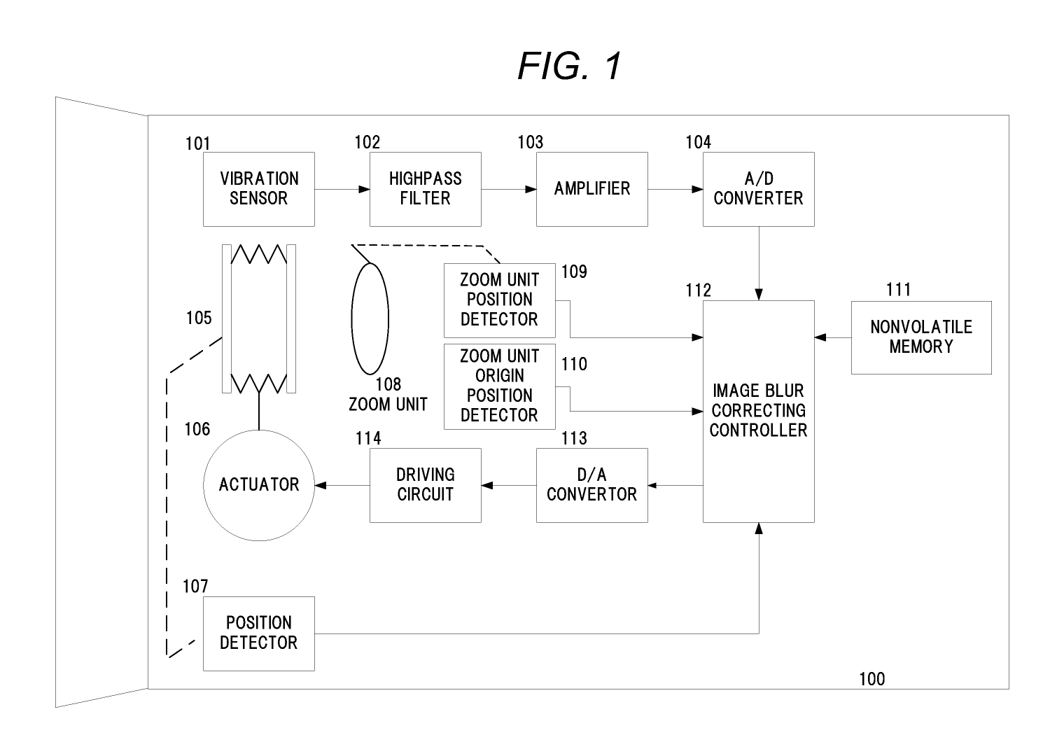

FIG. 1 is configuration diagram of a zoom lens apparatus having an image blur correcting function according to a first embodiment to which the present invention is applicable.

A zoom lens 100 having an image blur correcting function includes a vibration sensor 101 for detecting vibration applied to the zoom lens 100 having an image blur correcting function. A high-pass filter 102 removes a direct current component contained in an output signal from the vibration sensor 101, and an amplifier 103 amplifies an output from the high-pass filter 102 up to an appropriate level. An analog signal output from the amplifier 103 is converted into digital data by an A/D converter 104.

A variable apex angle prism 105 is a movable optical unit for decentering an optical axis of the zoom lens 100 (displacing an object image on an image plane). The variable apex angle prism 105 is driven by an actuator 106.

A position of the variable apex angle prism 105, that is, a relative angle between an incident surface and an exit surface (apex angle within a cross section including the optical axis), is detected by a position detector 107. In this case, by driving the above-mentioned variable apex angle prism 105 (varying the relative angle between the incident surface and the exit surface), the object image is displaced in a direction perpendicular to the optical axis (a movement amount of the object image relative to an image pickup element is reduced).

A zoom unit (magnification-varying lens unit) 108 is a lens unit that moves in an optical axis direction during magnification, and is arranged in an image plane side of the variable apex angle prism 10 (the variable optical unit (variable apex angle prism) 105 is arranged in an object side of the magnification-varying lens unit (zoom unit) 108. A position of the zoom unit 108 is detected by a zoom unit position detector 109. A zoom unit origin position detector 110 detects that the zoom unit 108 has passed through a predetermined origin position (reference position) while the zoom unit 108 is being driven.

A nonvolatile memory 111 stores coefficients necessary for computing image blur correction controlling data.

An image blur correcting controller 112 computes the image blur correction controlling data by using output data from the A/D converter 104, output data from the zoom unit position detector 109 and the zoom unit origin position detector 110, and the coefficients stored in the nonvolatile memory 111. Output data from the image blur correcting controller 112 is converted into an analog signal by a D/A converter 113 and, base on an output signal from the D/A converter 113, a driving circuit 114 drives the actuator 106.

The zoom unit position detector 109 is an incremental detector (sensor), which detects at sampling intervals a relative change amount (relative position) between a current detection value and the last detection value, and outputs the change amount to the image blur correcting controller 112. The image blur correcting controller (position computing unit) 112 adds/subtracts the input change amount to/from a stored zoom position, to thereby obtain a current zoom position. Therefore, in order to grasp the zoom position accurately, it is essential to initialize the zoom position stored in the zoom unit origin position detector 110 to the origin position based on an origin detecting signal from the zoom unit origin position detector 110, the origin detection signal being obtained when the zoom unit 108 passes through the predetermined zoom position (origin).

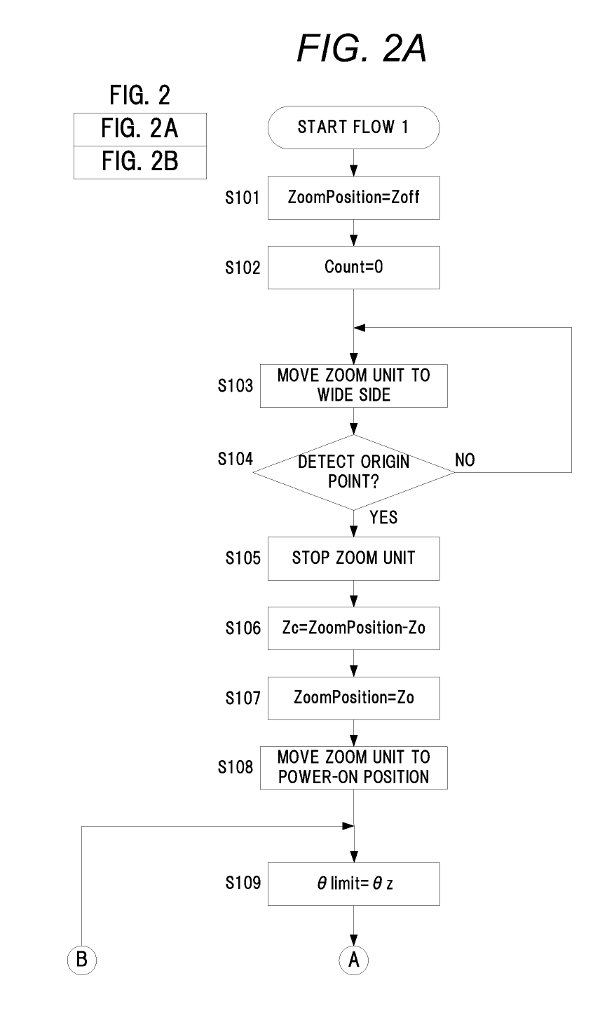

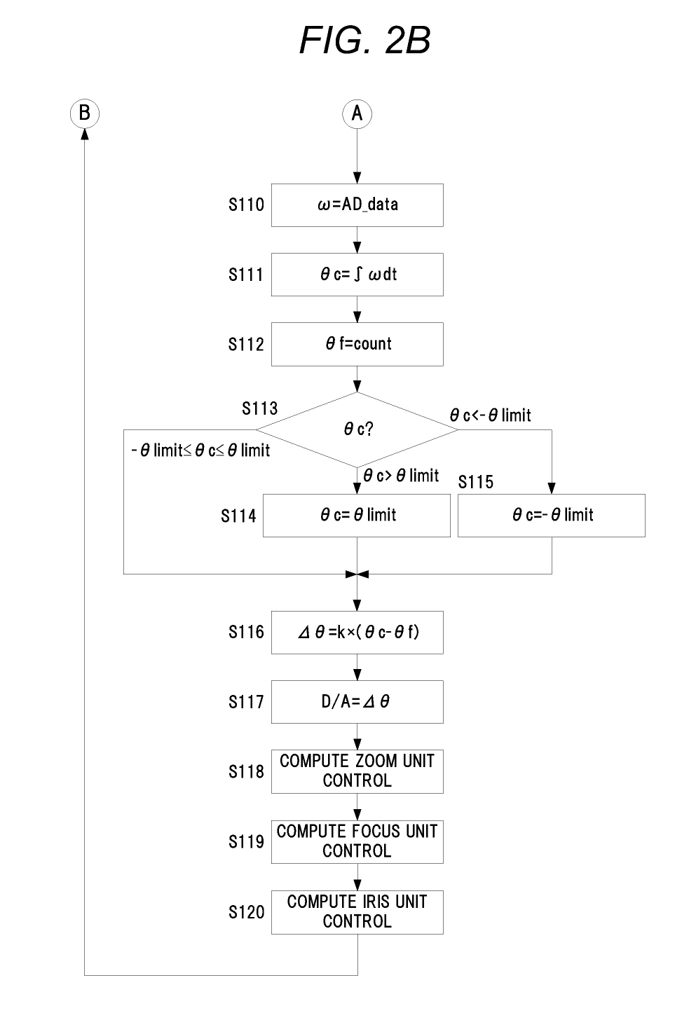

FIGS. 2A and 2B are flow chart illustrating a series of operation performed by the image blur correcting controller 112 according to this embodiment. The image blur correcting function is implemented by driving the variable apex angle prism 105 capable of rotating about rotation axes extending in two directions shifted by 90 degrees from each other. The variable apex angle prism 105 is driven in the respective two directions by using sets of two identical components such as the vibration sensors for performing the same processing. Hence, the description of this embodiment is directed only to the horizontal direction out of the two directions shifted by 90 degrees from each other, and description of the other direction, that is, the vertical direction is therefore omitted herein.

Hereinbelow, referring to the flow chart of FIGS. 2A and 2B, the operation performed by the image blur correcting controller 112 is described.

When power is supplied from a camera (not shown) to the zoom lens 100 having an image blur correcting function, the image blur correcting controller 112 proceeds to Step S101 to temporarily set a counter ZoomPosition of the zoom unit position detector 109 to an initial value Zoff.

ZoomPosition=Zoff (1)

At this time, the counter ZoomPosition of the zoom unit position detector 109 need not indicate an actual position of the zoom unit 108.

In Step S102, the image blur correcting controller 112 sets a counter Count of the position detector 107 corresponding to the angle of the variable apex angle prism 105 to 0. The counter Count outputs a value proportional to the angle of the variable apex angle prism 105, and corresponds to a counter that counts output pulses of an incremental encoder.

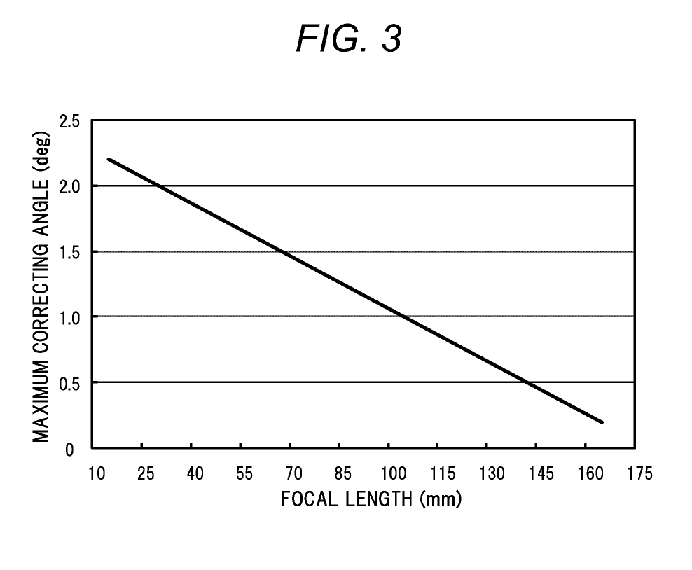

FIG. 3 shows a relationship between a focal length and an image blur correcting angle according to this embodiment. As shown in FIG. 3, in this embodiment, the maximum image blur correcting angle is set smaller as the focal length increases so that an amount of chromatic aberration caused during image blur correction is reduced. In other words, a variable range (movable range) of the image blur correcting angle is largest at a wide angle end, while decreasing monotonously as magnification is performed from the wide angle end toward a telephoto end, and is smallest at the telephoto end. This setting allows reduction in chromatic aberration, to thereby realize a high quality image that is applicable to high definition broadcast and the like. The description continues referring back to FIGS. 2A and 2B.

In this embodiment, the zoom unit origin position detector 110 is assumed to be arranged at the wide angle end, and hence the image blur correcting controller 112 drives the zoom unit 108 toward the wide side in Step S103 to detect the origin of the zoom unit.

Subsequently, in Step S104, the image blur correcting controller 112 determines whether or not the zoom unit origin position detector 110 has detected the origin. When the origin has not been detected, the processing returns to Step S103 to continue driving the zoom unit 108 toward the wide side until the origin position is detected. When the zoom unit origin position detector 110 has detected the origin in Step S104, on the other hand, the processing proceeds to Step S105 to stop driving the zoom unit 108 immediately, and proceeds to Step S106. In Step S106, the image blur correcting controller 112 reads an absolute position Zo corresponding to the origin position of the zoom unit from the nonvolatile memory 111, and computes a zoom position correcting value Zc using Expression (2).

Zc=ZoomPosition−Zo (2)

Further, in Step S107, the image blur correcting controller 112 sets the absolute position Zo at the origin position of the zoom unit to the counter ZoomPosition of the zoom unit position detector 109, and in Step S108, drives the zoom unit 108 toward a power-on position.

At this time, the counter ZoomPosition of the zoom unit position detector 109 matches with the actual position of the zoom unit 108. After that, by monitoring the counter ZoomPosition of the zoom unit position detector 109, the correct position of the zoom unit 108 may be grasped. The description still continues referring to FIGS. 2A and 2B.

The image blur correcting controller 112 proceeds to Step S109 to read, from the nonvolatile memory 111, a maximum value θz of the absolute values of the image blur correcting angle corresponding to the position of the zoom unit 108, and set the maximum value θz to an image blur correcting angle limit θlimit. Then, the processing proceeds to Step S110. In Step S110, the output of the vibration sensor 101 is converted into a digital signal by the A/D converter 104, and then the digital signal is set to vibration angular velocity data ω. Then, the processing proceeds to Step S111. In Step S111, using Expression (3) below, image blur correction controlling data θc corresponding to a vibration angle is computed based on the vibration angular velocity data, and then proceeds to Step S112.

θc=∫ωdt (3)

In Step S112, the image blur correcting controller 112 receives, from the position detector 107, position data θf corresponding to the angle of the variable apex angle prism 105, and in Step S113, compares the image blur correction controlling data θc to the image blur correcting angle limit θlimit.

When the image blur correcting control data θc is larger than the image blur correcting angle limit θlimit in Step S113, the processing proceeds to Step S114 to change the image blur correction controlling data θc according to Expression (4). Then, the processing proceeds to Step S116.

θc=θlimit (4)

When the image blur correction controlling data θc is smaller than an image blur correcting angle limit −θlimit in Step S113, the processing proceeds to Step S115 to change the image blur correction controlling data θc using Expression (5). Then, the processing jumps to Step S116.

θc=−θlimit (5)

Meanwhile, when the image blur correction controlling data θc satisfies a condition of Expression (6) in Step S113, the processing proceeds to Step S116.

−θlimit≦θc≦θlimit (6)

In Step S116, using Expression (7), the image blur correcting controller 112 computes a difference value Δθ between the image blur correction controlling data θc and the position data θf the variable apex angle prism 105, and proceeds to Step S117.

Δθ=k×(θc−θf) (7)

In Step S117, the image blur correcting controller 112 outputs the computed difference value Δθ to the D/A converter 113 to drive the actuator 106 so that the position of the variable apex angle prism 105 corresponds to θc.

Further, the image blur correcting controller 112 performs control computing for the zoom unit 108 in Step S118, control computing for a focus unit (not shown) in Step S119, and control computing for an iris unit (not shown) in Step S120.

After that, the image blur correcting controller 112 executes Steps S109 to S120 repeatedly until the power of the zoom lens 100 having an image blur correcting function is turned off.

As described above, the position of the zoom unit 108 is first initialized immediately after the power-on, and accordingly the image blur correction may be performed immediately after the power-on under the state in which the increase in chromatic aberration amount is suppressed.

This embodiment has been described by taking as an example the case where the zoom unit origin position detector 110 is arranged at the wide angle end, but the present invention is not limited thereto. In a case where the zoom unit origin position detector is arranged at a position other than the wide angle end, the same effect as in this embodiment may be obtained by appropriately setting the driving direction and target position of the zoom unit 108 in Step S103 depending on the arrangement.

Further, this embodiment has been described by taking as an example the case where the zoom unit 108 is arranged in the image plane side of the variable apex angle prism 105, but the same effect may be obtained also in a case where the image blur correcting unit 105 is arranged in the image plane side of the zoom unit 108.

### Second Embodiment

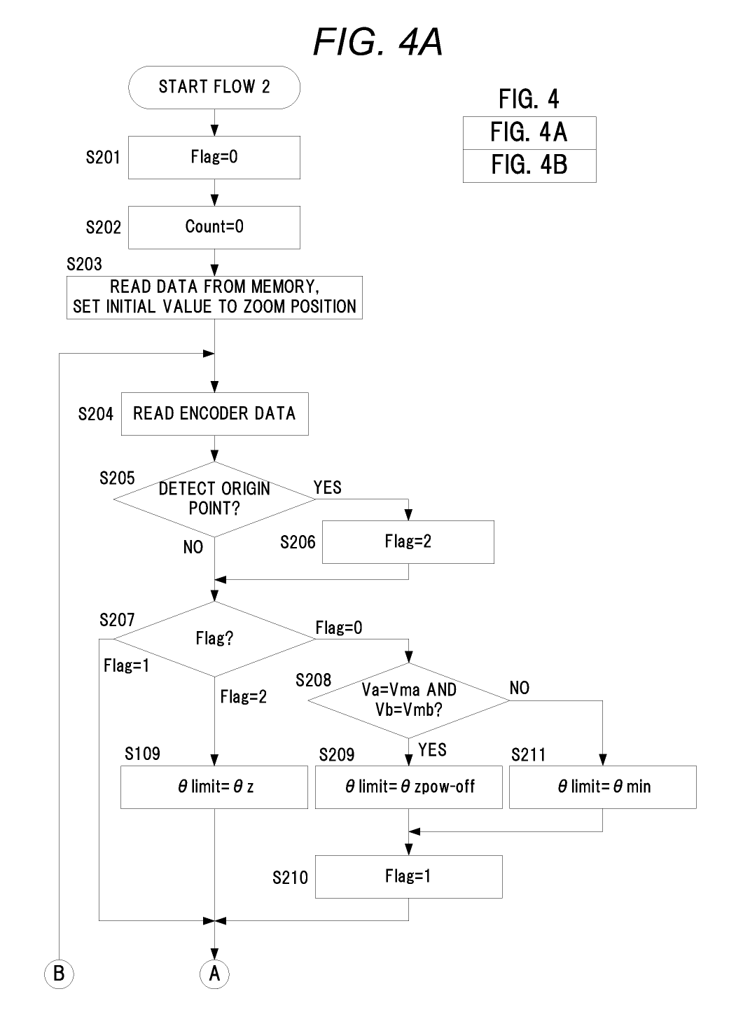

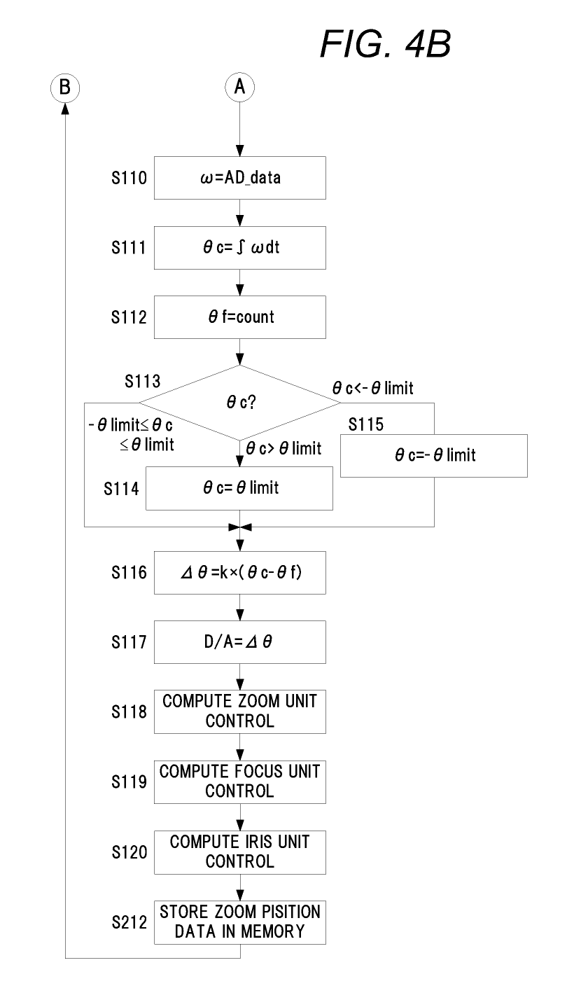

FIGS. 4A and 4B are flow chart illustrating a series of operation performed by the image blur correcting controller 112 according to this embodiment. The configuration of this embodiment is the same as that of the first embodiment, and description thereof is therefore omitted herein. Hereinbelow, referring to the flow chart of FIGS. 4A and 4B, the operation performed by the image blur correcting controller 112 is described.

When power is supplied from the camera (not shown) to the zoom lens 100 having an image blur correcting function, the image blur correcting controller 112 proceeds to Step S201 to set an initialization completion flag Flag to 0. In Step S202, the image blur correcting controller 112 sets the counter Count of the position detector 107 corresponding to the angle of the variable apex angle prism 105 to 0. Then, the processing proceeds to Step S203.

In Step S203, the image blur correcting controller 112 reads, from the nonvolatile memory 111, a state of the position detector 107, which has been stored in advance last time the power of the zoom lens 100 having an image blur correcting function is turned off. The image blur correcting controller 112 temporarily sets a read initial value Zpow-off to the counter ZoomPosition of the zoom unit position detector 109.

In Step S203, the following three values are read from the nonvolatile memory 111.

Vma: zoom encoder A phase data

Vmb: zoom encoder B phase data

Zpow-off: zoom position data

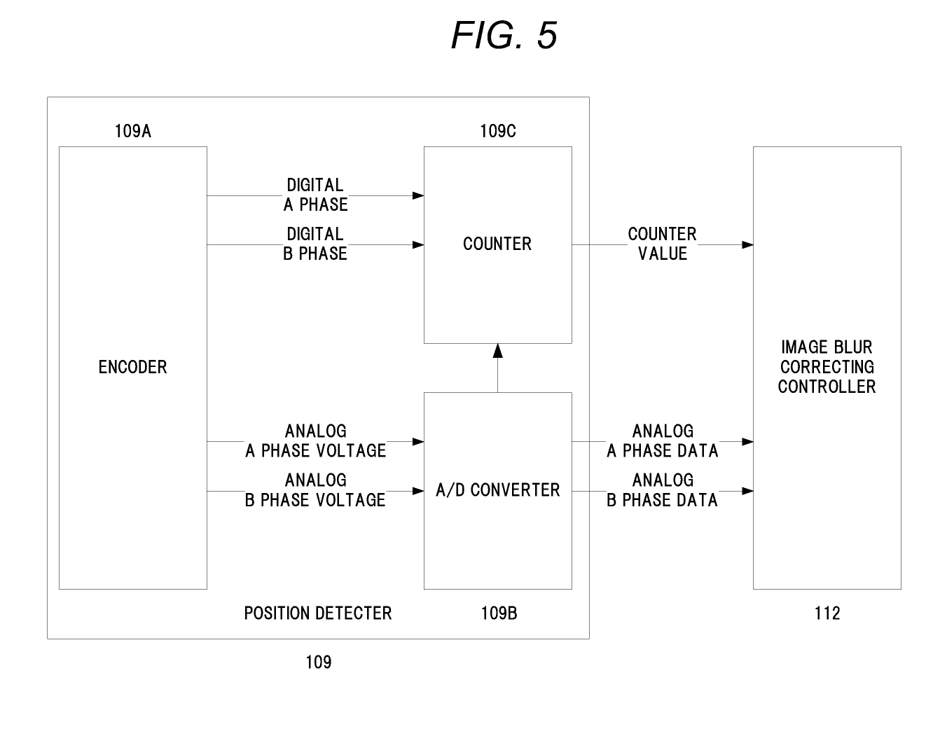

Hereinafter, the pieces of data Vma and Vmb are described. FIG. 5 illustrates a detailed configuration of the zoom unit position detector 109. In FIG. 5, an encoder 109A outputs rectangular waves and sinusoidal waves depending on the position of the zoom unit 108. The encoder 109A outputs two signals having phases shifted by 90 degrees as rectangular waves and as sinusoidal waves. An A/D converter 109B converts the two sinusoidal waves output from the encoder 109A into pieces of digital data. A counter 109C multiplies and discriminates the two rectangular waves output from the encoder 109A, and uses the output from the A/D converter 109B for counting a value corresponding to the position of the zoom unit 108. Then, the counter 109C outputs the value as a counter value to the image blur correcting controller 112. Further, the A/D converter 109B outputs, to the image blur correcting controller 112, the pieces of digital data obtained through the A/D conversion of the sinusoidal waves (analog A phase data and analog B phase data). In Step S203, the pieces of data Vma and Vmb read from the nonvolatile memory (position storing unit) 111 correspond to the pieces of digital data output from the A/D converter 109B to the image blur correcting controller 112.

The description continues referring back to FIGS. 4A and 4B.

In Step S204, the image blur correcting controller 112 reads pieces of output data Va and Vb of the zoom unit position detector 109 (A/D converter 109B). Then, the processing proceeds to Step S205 to determine whether or not the origin has been detected. When the origin has been detected in Step S205, the processing proceeds to Step S206 to set the initialization completing flag Flag to 2, and proceeds to Step S207. When the origin has not been detected in Step S205, the processing proceeds to Step S207.

When the initialization completing flag Flag indicating whether or not the initialization of the zoom position has been completed is 0 in Step S207, the processing proceeds to Step S208. When the initialization completing flag Flag is 1, the processing proceeds to Step S110. When the initialization completion flag Flag is 2, the processing proceeds to Step S109.

In Step S208, the image blur correcting controller 112 compares Vma to Va, and Vmb to Vb, which have been read in Steps S203 and S204. When Vma equals Va and Vmb equals Vb, the image blur correcting controller 112 may determine that the current zoom position matches with the last zoom position at the time when the power of the zoom lens 100 having an image blur correcting function is turned off. In this case, the processing proceeds to Step S209 to read, from the nonvolatile memory, an image blur correcting angle limit value θzpow-off corresponding to the zoom position Zpow-off that has been read in Step S203, and set the image blur correcting angle limit value θzpow-off to the buffer θlimit. Then, the processing proceeds to Step S210.

When Vma does not equal Va or Vmb does not equal Vb in Step S208, the processing proceeds to Step S211, and sets a minimum correcting angle limit value within the entire zoom range to the buffer θlimit. With this setting, irrespective of where the zoom position is, the chromatic aberration caused by the image blur correction may be suppressed. Subsequently, the processing proceeds to Step S210.

In Step S210, the image blur correcting controller 112 sets the initialization completion flag Flag to 1, and proceeds to Step S110.

When the initialization completion flag Flag is 2 in Step S207, the processing proceeds to Step S109 to read, from the nonvolatile memory 111, the image blur correcting angle limit value θz corresponding to the current zoom position, and set the image blur correcting angle limit value θz to the buffer θlimit. Then, the processing proceeds to Step S110.

Steps S110 to S120 are the same as those of the first embodiment, and description thereof is therefore omitted herein. The image blur correcting controller 112 that has completed the processing of Step S120 proceeds to Step S212 to store the zoom position data and the output data of the position detector 107 in the nonvolatile memory 111.

After that, the image blur correcting controller 112 executes Steps S204 to S120 and S212 repeatedly until the power of the zoom lens 100 having an image blur correcting function is turned off.

The same effect may be obtained even if the determination condition of Step S208 is set to a range such as Vma−α>Va>Vma+α.

According to the method of this embodiment, when the position of the zoom unit at the time of power-on matches with the last position of when the power is turned off, the maximum correcting angle at the zoom position is set to the maximum correcting angle limit value within the entire zoom range, and when the position of the zoom unit at the time of power-on does not match with the last position of when the power is turned off, the minimum value of the maximum correcting angle limit value within the entire zoom range is set to the maximum correcting angle limit value within the entire zoom range. Then, images may be taken until the origin point is detected during the image taking. In a case where strict image blur correction and chromatic aberration reduction are not given priority in image taking, this configuration produces an effect that the image taking may be started immediately after the power-on with a certain level of image blur correction effect while the chromatic aberration is suppressed.

As described above, by monitoring the output of the zoom unit position detector 109 and setting the image blur correcting angle limit value depending on the state thereof, the chromatic aberration amount may be reduced immediately after the power-on.

### Third Embodiment

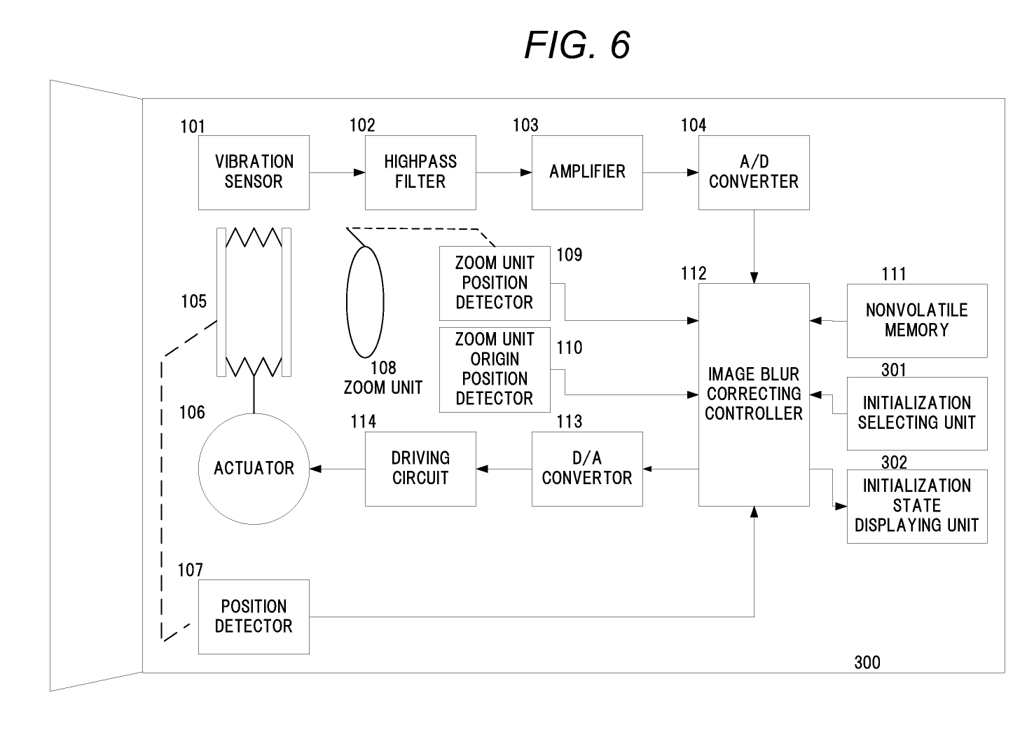

FIG. 6 is configuration diagram of a zoom lens apparatus having an image blur correcting function according to a third embodiment to which the present invention is applicable. In addition to the components of the first embodiment illustrated in FIG. 1, this embodiment employs an initialization selecting unit 301 for switching whether to initialize the zoom position stored in the image blur correcting controller 112 to the origin position immediately after the power-on, and also employs an initialization state displaying unit 302 for displaying whether or not the initialization has been completed.

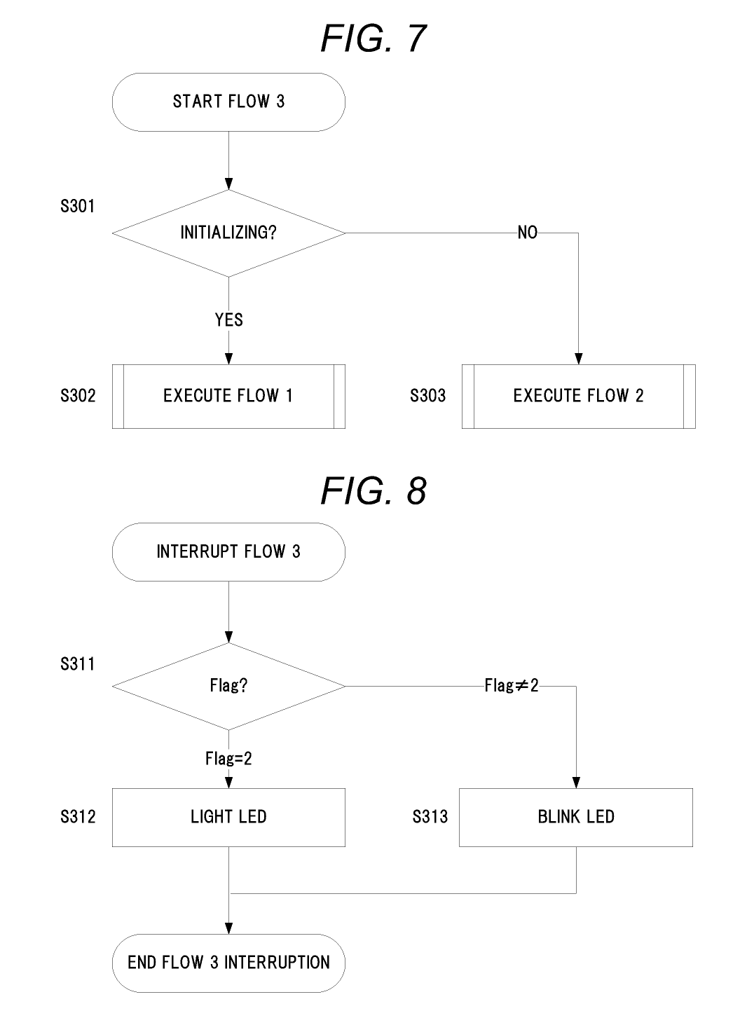

FIGS. 7 and 8 are flow charts each illustrating a series of operation performed by the image blur correcting controller 112 according to this embodiment. Hereinbelow, referring to the flow charts of FIGS. 7 and 8, the operation performed by the image blur correcting controller 112 is described.

When power is supplied from the camera (not shown) to a zoom lens 300 having an image blur correcting function, the image blur correcting controller 112 proceeds to Step S301 to determine the state of the initialization selecting unit 301.

When the initialization selecting unit 301 is set so as to perform initialization (so as to execute processing of initializing the zoom position stored in the image blur correcting controller 112 to the origin position immediately after the power-on) in Step S301, the processing proceeds to Step S302 to execute Flow 1 of the first embodiment illustrated in FIGS. 2A and 2B. When the initialization selecting unit 301 is set so as not to perform initialization (is not set so as to initialize the zoom position stored in the processing to the origin position immediately after the power-on) in Step S301, the image blur correcting controller 112 proceeds to Step S303 to execute Flow 2 of the second embodiment illustrated in FIGS. 4A and 4B. The processing of Flows 1 and 2 is the same as that of the first and second embodiments, and detailed description thereof is therefore omitted herein.

Further, the image blur correcting controller 112 performs the series of operation illustrated in the flow chart of FIG. 8 depending on an interrupting signal that is generated every predetermined time. When the interrupting signal is generated, in Step S311, the image blur correcting controller 112 determines the initialization completing flag Flag. When the initialization completing flag Flag is 2 in Step S311, the processing proceeds to Step S312 to light an LED of the initialization state displaying unit 302 and complete the interrupting process. When the initialization completing flag Flag is not 2 in Step S311, on the other hand, the processing jumps to Step S313 to blink the LED of the initialization state displaying unit 302 and complete the interrupting process. This interrupting process allows an operator to recognize whether or not the current zoom position stored in the image blur correcting controller 112 has been initialized to the origin position, with the result that the operator may take an appropriate action. For example, when the initialization is not completed, initialization of the image blur correcting controller 112 may be performed by forcibly driving the zoom unit.

As described above, by monitoring the state of the initialization selecting unit 301 and setting the image blur correcting angle limit value depending on the state, the chromatic aberration amount may be reduced immediately after the power-on.

### Fourth Embodiment

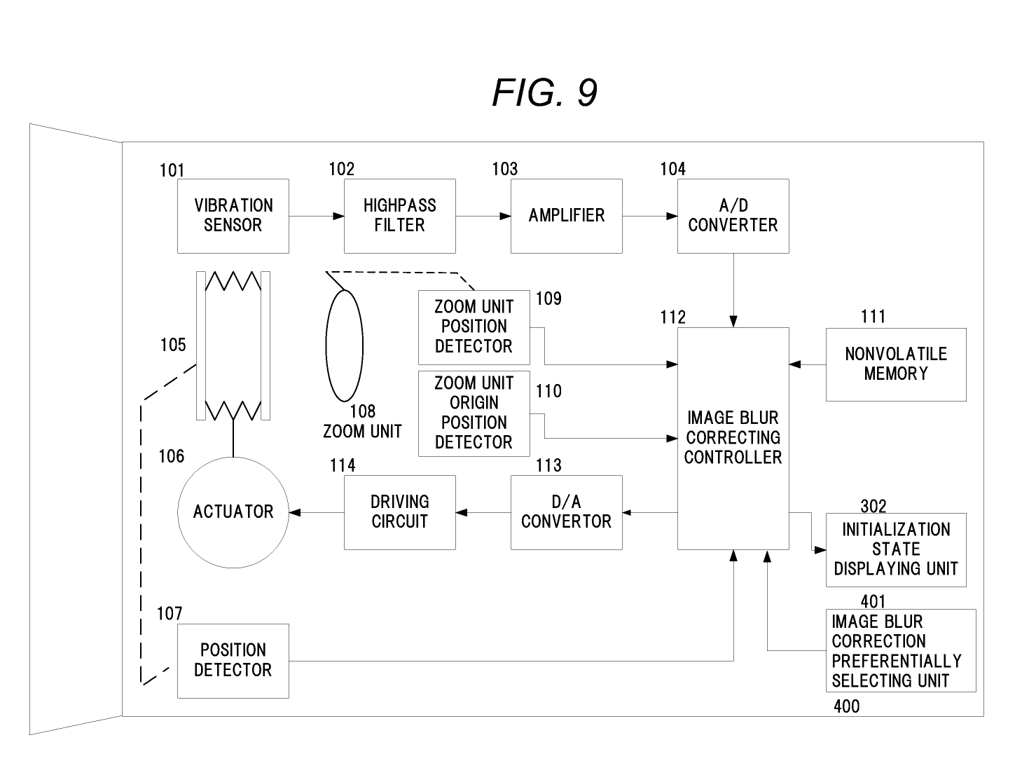

FIG. 9 is configuration diagram of a zoom lens apparatus having an image blur correcting function according to a fourth embodiment to which the present invention is applicable. Instead of the initialization selecting unit 301 as one of the components of the third embodiment illustrated in FIG. 6, this embodiment employs a configuration in which an image blur correction preferentially-selecting unit 401 for setting a mode of the image blur correction is provided.

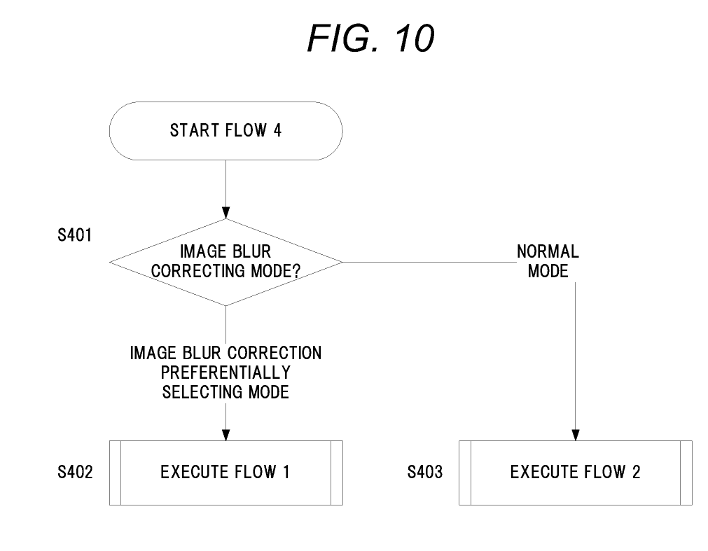

FIG. 10 is a flow chart illustrating a series of operation performed by the image blur correcting controller 112 according to this embodiment. Hereinbelow, referring to the flow chart of FIG. 10, the operation performed by the image blur correcting controller 112 is described.

When power is supplied from the camera (not shown) to a zoom lens 400 having an image blur correcting function, the image blur correcting controller 112 starts the processing from Step S401 to determine the state of the image blur correction preferentially-selecting unit 401. When the image blur correction preferentially-selecting unit 401 is set to an image blur correction preferentially-selecting mode in Step S401, the processing proceeds to Step S402 to execute Flow 1 illustrated in FIGS. 2A and 2B. When the image blur correction preferentially-selecting unit 401 is set to a normal mode in Step S401, on the other hand, the processing proceeds to Step S403 to execute Flow 2 illustrated in FIGS. 4A and 4B. The processing of Flows 1 and 2 is the same as that of the first and second embodiments, and detailed description thereof is therefore omitted herein. Further, the processing regarding the initialization state displaying unit 302 is the same as that of FIG. 8 described in the third embodiment, and description thereof is therefore omitted herein.

By performing the processing of Flow 4 of this embodiment, when the image blur correction preferentially-selecting mode is set, the processing of initializing the zoom position stored in the image blur correcting controller 112 to the origin position immediately after the power-on is executed, and then the image taking may be performed. Accordingly, the image blur correction may be performed with the maximum image blur correcting control amount depending on the zoom position within the entire zoom range. When the image blur correction preferentially-selecting mode is not set, on the other hand, the image taking operation may be performed immediately after the power-on without executing the processing of initializing the image blur correcting controller 112. When the zoom unit origin position detector 110 detects the origin position during the image taking, the zoom position is initialized as appropriate through Steps S208 and S211.

As described above, by monitoring the state of the image blur correction preferentially-selecting unit 401 and setting the image blur correcting angle limit value depending on the state, the chromatic aberration amount may be reduced immediately after the power-on.

### Fifth Embodiment

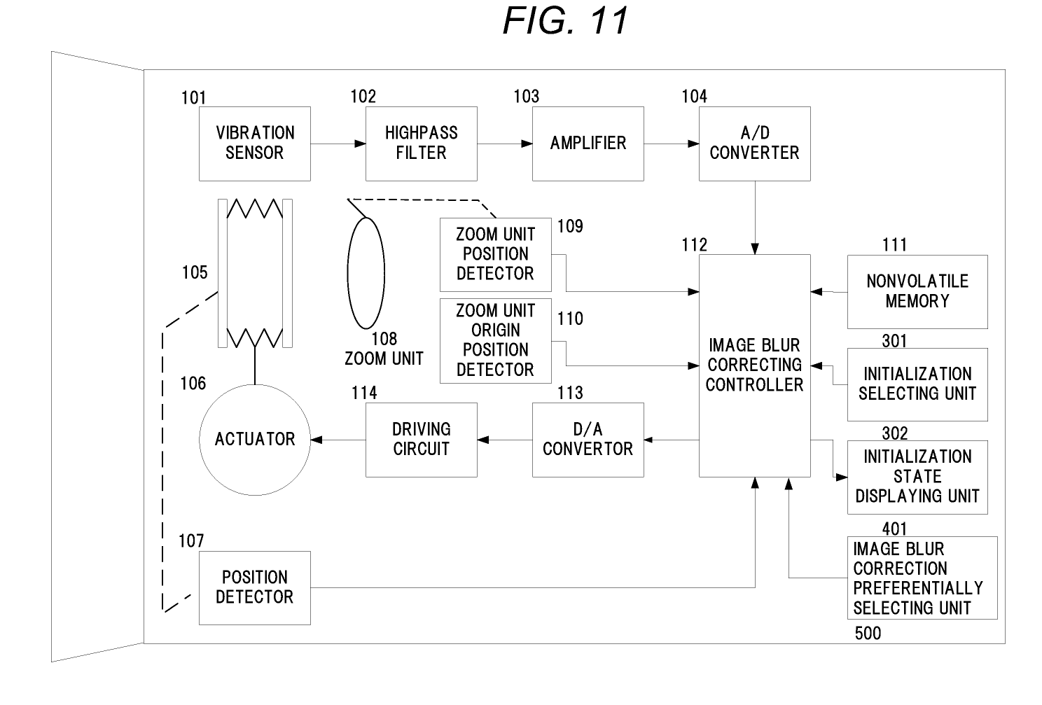

FIG. 11 is configuration diagram of a zoom lens apparatus having an image blur correcting function according to a fifth embodiment to which the present invention is applicable. In addition to the components of the third embodiment illustrated in FIG. 6, this embodiment employs a configuration in which the image blur correction preferentially-selecting unit 401 for setting a mode of the image blur correction is further provided.

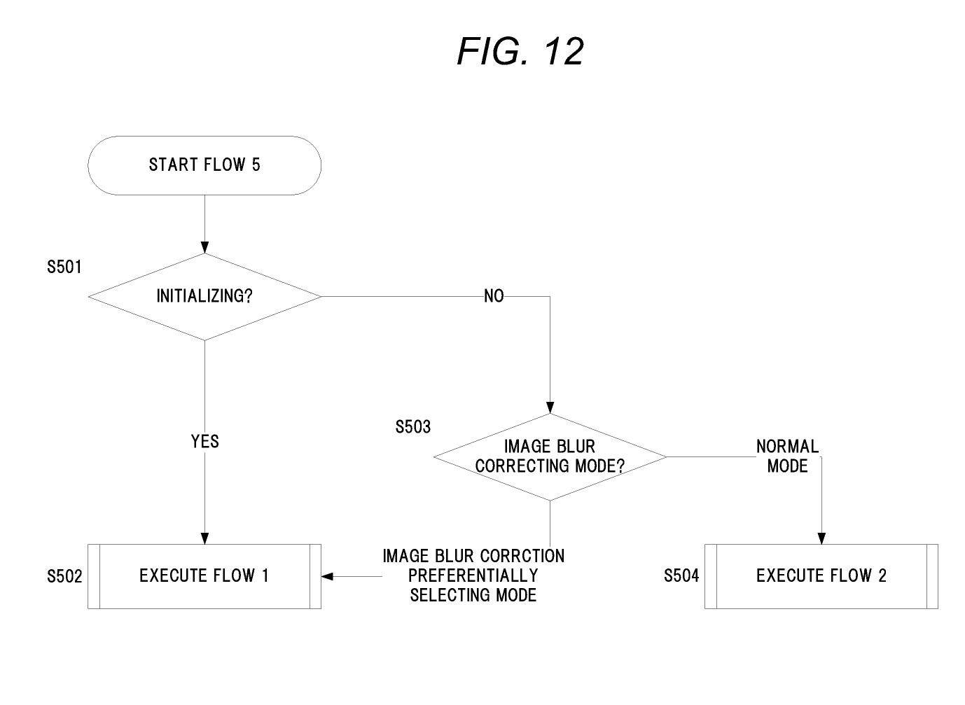

FIG. 12 is a flow chart illustrating a series of operation performed by the image blur correcting controller 112 according to this embodiment. Hereinbelow, referring to the flow chart of FIG. 12, the operation performed by the image blur correcting controller 112 is described.

When power is supplied from the camera (not shown) to a zoom lens 500 having an image blur correcting function, the image blur correcting controller 112 starts the processing from Step S501 to determine the state of the initialization selecting unit 301. When the initialization selecting unit 301 is set so as to perform initialization (so as to execute processing of initializing the zoom position stored in the image blur correcting controller 112 to the origin position immediately after the power-on) in Step S501, the processing proceeds to Step S502 to execute Flow 1 illustrated in FIGS. 2A and 2B. When the initialization selecting unit 301 is set so as not to perform initialization (is not set so as to initialize the zoom position stored in the image blur correcting controller 112 to the origin position immediately after the power-on) in Step S501, the processing proceeds to Step S503 to determine the state of the image blur correction preferentially-selecting unit 401. When the image blur correction preferentially-selecting unit 401 is set to the image blur correction preferentially-selecting mode in Step S503, the processing proceeds to Step S502 to execute Flow illustrated in FIGS. 2A and 2B. When the image blur correction preferentially-selecting unit 401 is set to the normal mode in Step S503, on the other hand, the processing proceeds to Step S504 to execute Flow 2 illustrated in FIGS. 4A and 4B. The processing of Flows 1 and 2 is the same as that of the first and second embodiments, and detailed description thereof is therefore omitted herein. Further, the processing regarding the initialization state displaying unit 302 is the same as that of FIG. 8 described in the third embodiment, and description thereof is therefore omitted herein.

As described above, by monitoring the states of the initialization selecting unit 301 and the image blur correction preferentially-selecting unit 401, and setting the image blur correcting angle limit value depending on the states, the chromatic aberration amount may be reduced immediately after the power-on.

The above-mentioned embodiments have exemplified the variable apex angle prism 105 being a prism member as a movable optical unit for image blur correction, which displaces the object image on the image plane. However, the present invention is not limited thereto, and it should be noted that the effect of the present invention may be obtained also when an optical element movable in a direction perpendicular to the optical axis is employed. In this case, the image blur correcting controller 112 controls the optical element so that the movable range of the optical element within a plane perpendicular to the optical axis is larger at the wide angle end than at the telephoto end.

Further, the above-mentioned embodiments have described that the zoom unit (magnification-varying lens unit) 108 is arranged in the image plane side of the movable optical unit (variable apex angle prism 105) for image blur correction. It should be noted that the same effect as that of the present invention may be obtained also in a case where another lens unit is arranged in the object side than the movable optical unit (variable apex angle prism 105) for image blur correction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-063688, filed Mar. 19, 2010, which is hereby incorporated by reference herein in its entirety.

What is claimed is:

1. A zoom lens, comprising:
a magnification-varying lens unit, which moves in an optical axis direction during varying magnification;
an optical unit, which is movable and arranged in an object side of the magnification-varying lens unit; and
a controller for moving the optical unit,
wherein the optical unit is moved to displace an image, and
wherein a movable range of the optical unit at a wide angle end is larger than a movable range of the optical unit at a telephoto end.

2. A zoom lens according to claim 1,
wherein the optical unit comprises an optical element in which a relative angle between an incident surface and an exit surface is variable,
wherein the movable range of the optical unit comprises a variable range of the relative angle between the incident surface and the exit surface, and
wherein the controller controls the optical element so that the variable range at the wide angle end is larger than the variable range at the telephoto end.

3. A zoom lens according to claim 2, wherein the optical element comprises a prism member in which an apex angle is variable within a cross section including an optical axis.

4. A zoom lens according to claim 1,
wherein the optical unit comprises an optical element movable in a direction perpendicular to an optical axis,
wherein the movable range of the optical unit comprises a movable range of the optical element within a plane perpendicular to the optical axis, and
wherein the controller controls the optical element so that the movable range at the wide angle end is larger than the movable range at the telephoto end.

5. A zoom lens according to claim 1, wherein the movable range decreases monotonously as the magnification is varied from the wide angle end to the telephoto end.

6. A zoom lens according to claim 1, further comprising a lens unit arranged in an object side of the optical unit.

7. A zoom lens according to claim 1, further comprising:
a position detecting unit for detecting a relative position of the magnification-varying lens unit; and
a position computing unit for computing a position of the magnification-varying lens unit based on the detected relative position of the magnification-varying lens unit,
wherein the magnification-varying lens unit is driven to a reference position immediately after power-on, then the position of the magnification-varying lens unit stored in the position computing unit is initialized to the reference position, then the magnification-varying lens unit is driven to a position at the time of the power-on, and then the movable range of the optical unit according to the position of the magnification-varying lens unit is set.

8. A zoom lens according to claim 7, further comprising a position storing unit for storing a position of the magnification-varying lens unit at the time when power of the zoom lens is turned off,
wherein, when the position of the magnification-varying lens unit stored in the position computing unit is not initialized, the movable range of the optical unit according to a state of the position storing unit is set.

9. A zoom lens according to claim 1, further comprising:
a position detecting unit for detecting a relative position of the magnification-varying lens unit;
a position computing unit for computing a position of the magnification-varying lens unit based on the detected relative position of the magnification-varying lens unit;
an initialization selecting unit for selecting a method of initializing the position of the magnification-varying lens unit stored in the position computing unit; and
a position storing unit for storing a position of the magnification-varying lens unit at the time when power of the zoom lens is turned off,
wherein, when the initialization selecting unit is set so as to perform initialization, the magnification-varying lens unit is driven to a reference position immediately after power-on, then the position of the magnification-varying lens unit stored in the position computing unit is initialized to the reference position, then the magnification-varying lens unit is driven to a position at the time of the power-on, and then the movable range of the optical unit according to the position of the magnification-varying lens unit is set, and
wherein, when the initialization selecting unit is set so as not to perform the initialization, the movable range of the optical unit according to a state of the position storing unit is set.

10. A zoom lens according to claim 7, further comprising a correction preferentially-selecting unit,
wherein, when the correction preferentially-selecting unit is set to an image blur correction preferentially-selecting mode, the magnification-varying lens unit is driven to a reference position immediately after power-on, then the magnification-varying lens unit is driven to a position at the time of the power-on, and then the movable range of the optical unit according to the position of the magnification-varying lens unit is set.
